(19) United States
(12) Patent Application Publication
(10) Pub. No.: US 2025/0278452 A1
(43) Pub. Date: Sep. 4, 2025

(54) TECHNIQUES FOR THREAD REDUCTION IN PROCESSING TENSORS UTILIZING SPARSITY DETECTION

(71) Applicant: Think Silicon Research and Technology Single Member S.A., Rion Achaias (GR)

(72) Inventors: Dimitrios TSALIAGKOS, Athens (GR); Nikolaos MITAS, Patras (GR); Georgios KERAMIDAS, Patras (GR)

(73) Assignee: Think Silicon Research and Technology Single Member S.A., Rion Achaias (GR)

(21) Appl. No.: 18/061,324

(22) PCT Filed: Nov. 24, 2022
(86) PCT No.: PCT/GR2022/000066

§ 371 Date: Dec. 2, 2022

(51) Int. Cl. G06F 17/16; G06F 9/30

(52) U.S. Cl. CPC G06F 17/16; G06F 9/3009

(57) ABSTRACT

A system and method reduces thread spawning in processing tensor inputs. The method includes generating a result of a block of a tensor input with a predefined kernel on a processing circuitry, the processing circuitry configured to process in parallel a plurality of threads; performing a depth test on the generated result; generating for an indicator bit a first indicator bit value based on the depth test, the first indicator bit value indicating that the result is sparse; generating for the indicator bit a second indicator bit value based on the depth test, the second indicator bit value indicating that the result is not sparse; and spawning a thread for processing the result and a second predefined kernel, based on the indicator bit having the second indicator bit value.

### TECHNICAL FIELD

The present disclosure relates generally to tensor processing and specifically to thread reduction utilizing sparsity.

### BACKGROUND

A convolution is a computation in which a first signal, or function, is used to modify a second signal, or function. Such computations are useful in many technology areas, such as processing seismic signals in oil exploration, convolutional neural networks, applying filters to images, and the like.

Computation of convolutions may be performed on a processing circuitry, such as a general purpose graphic processing unit (GPGPU) which is capable of performing many of the same computation in parallel. In computer processing of functions, each computation requires power to be supplied to the processor, memory utilization, and the like. Furthermore, each computation takes some finite amount of time to be performed.

Various optimizations to computations exist, which aim to reduce the amounts of memory, power, or time, which it takes for a processing circuitry to perform processing.

Specifically, for convolutional neural networks, some techniques attempt to generate sparse filters, which can then be efficiently calculated. For example, a filter containing all zeros has an output which is independent of the input, thus allowing to utilize a cached value in place of performing a calculation, which results in reduced use of processing resources.

Such techniques are utilized in the training phase of the convolutional neural network, and therefore do not improve unless the neural network is retrained. Some techniques are known as pruning techniques, which attempt to reduce the amount of computation that is performed when processing an input for a neural network. However, these techniques always provide a static solution, which cannot adapt and therefore is limited in the benefit that can be achieved.

It would therefore be advantageous to provide a solution that would overcome the challenges noted above, and specifically to improve processing of tensors on a processing circuitry.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for thread reduction in tensor processing. The method comprises: generating a result of a block of a tensor input with a predefined kernel on a processing circuitry, the processing circuitry configured to process in parallel a plurality of threads; performing a depth test on the generated result; generating for an indicator bit a first indicator bit value based on the depth test, the first indicator bit value indicating that the result is sparse; generating for the indicator bit a second indicator bit value based on the depth test, the second indicator bit value indicating that the result is not sparse; and spawning a thread for processing the result and a second predefined kernel, based on the indicator bit having the second indicator bit value.

Certain embodiments disclosed herein also include a non-transitory computer readable medium having stored thereon causing a processing circuitry to execute a process, the process comprising: generating a result of a block of a tensor input with a predefined kernel on a processing circuitry, the processing circuitry configured to process in parallel a plurality of threads; performing a depth test on the generated result; generating for an indicator bit a first indicator bit value based on the depth test, the first indicator bit value indicating that the result is sparse; generating for the indicator bit a second indicator bit value based on the depth test, the second indicator bit value indicating that the result is not sparse; and spawning a thread for processing the result and a second predefined kernel, based on the indicator bit having the second indicator bit value.

Certain embodiments disclosed herein also include a system for thread reduction in tensor processing. The system comprises: a processing circuitry; and a memory, the memory containing instructions that, when executed by the processing circuitry, configure the system to: generate a result of a block of a tensor input with a predefined kernel on a processing circuitry, the processing circuitry configured to process in parallel a plurality of threads; perform a depth test on the generated result; generate for an indicator bit a first indicator bit value based on the depth test, the first indicator bit value indicating that the result is sparse; generate for the indicator bit a second indicator bit value based on the depth test, the second indicator bit value indicating that the result is not sparse; and spawn a thread for processing the result and a second predefined kernel, based on the indicator bit having the second indicator bit value.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a schematic diagram of a processing circuitry for processing a tensor, implemented in accordance with an embodiment.

FIG. 2 is a flowchart of a method for processing an input on a parallel processing circuitry utilizing a reduced thread spawn scheme, implemented in accordance with an embodiment.

FIG. 3 is a flowchart of a method for spawning threads in a processing circuitry, implemented in accordance with an embodiment.

FIG. 4 is a flowchart of a method for determining a sparse tensor utilized in spawning threads in a processing circuitry, implemented in accordance with an embodiment.

FIG. 5 is a schematic diagram of a system utilizing a processing pipeline for reducing thread spawning, implemented according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. in the drawings, like numerals refer to like parts through several views.

The various disclosed embodiments include a method and system for reducing thread spawning in a parallel processing pipeline. In an embodiment, an input is processed with a kernel to generate an output. Blocks of the output are provided to a depth test unit, such as a z-buffer, to determine if the blocks are sparse (e.g., contain all, or mostly, zero values), or not sparse. In an embodiment, an indicator bit is updated with a value which indicates the state (i.e., sparse or not sparse) of a block, group of blocks, and the like.

The indicator bit value is provided to a scheduler, such as a rasterizer in a GPU pipeline, which determines if a thread should be spawned based on the value of the indicator bit. By spawning threads only for blocks which are not sparse, a reduction in the number of threads spawned is achieved. This allows, in an embodiment, to process less threads, thereby utilizing less cores of a multi-core processing circuitry, which in turn saves power consumption. In other embodiments, this allows to process additional threads in place of threads which would result in a zero result (regardless of their input), thereby reducing the time it takes to process an entire input.

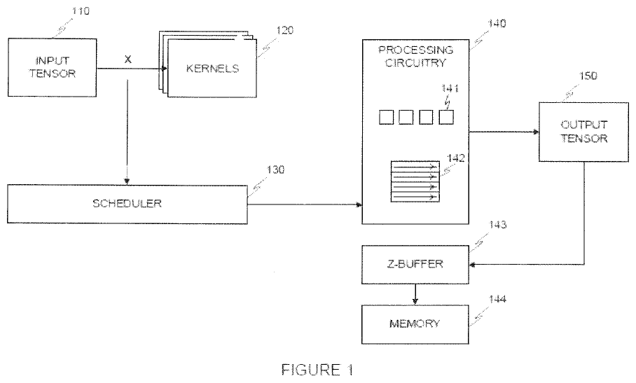

FIG. 1 is an example schematic diagram of a processing circuitry for processing a tensor, implemented in accordance with an embodiment. In an embodiment, the processing circuitry 140 is a parallel processing circuitry, such as graphics processing unit (GPU), a general purpose graphics processing unit (GPGPU), and the like. In certain embodiments, the processing circuitry 140 includes a plurality of cores, each core configured to process a thread based on an instruction generated by a scheduler 130. In some embodiments the processing circuitry 140 includes a core which is configured to process multiple threads, a core which is configured to process a single thread, and combinations thereof.

In an embodiment, the processing circuitry 140 is configured to process an input tensor 110 based on a kernel 120. In some embodiments, the input tensor is a two-dimensional matrix, an array, and the like. A kernel 120 is, in an embodiment, a matrix of values stored in a memory, storage, and the like. In certain embodiments, the kernel 120 is a filter, a layer, and the like. In some embodiments, the processing circuitry 140 is configured to perform a convolution between the input tensor 110 and a kernel 120. In some embodiments, a plurality of kernels are utilized.

According to an embodiment, pruning a kernel 120 is advantageous. For example, in some embodiments structured pruning is performed on a kernel 120. Structured pruning includes, in an embodiment, setting all values of a kernel to zero. In certain embodiments unstructured pruning is performed on a kernel 120. Unstructured pruning includes, in an embodiment, setting a value of a kernel to zero, wherein the kernel includes at least a second value which is non-zero.

In certain embodiments, processing an input tensor 110 includes generating a plurality of input blocks from the input tensor 110, each input block having a predefined size. For example, an input block represents, in an embodiment, a 4 by 4 pixel block, a 2 by 2 pixel block, and the like.

In certain embodiments, an input tensor 110 can be split into a plurality of blocks, where a first block of the plurality of blocks has a first size (e.g., 2 by 4), and a second block of the plurality of blocks has a second size (e.g., 4 by 4).

In some embodiments, the input tensor 110, the kernel 120, a block, a combination thereof, and the like, are quantized. In an embodiment, quantizing a value includes converting the value from a floating point value to an integer value. This is advantageous as a floating point value is more precise, therefore requires more memory to store. For example, quantizing a value from a floating point to an integer reduces a representation from 32 bits per value to 8 bits per value, according to an embodiment.

In some embodiments, a size of a block and size of a kernel are provided to a scheduler 130. The scheduler 130 is configured, in an embodiment, to perform thread scheduling for the processing circuitry 140. In some embodiments, thread scheduling is performed by a thread dispatcher, a thread generator, and the like. In an embodiment, a thread is the minimal sequence of instructions which can be performed by a processing circuitry, a core thereof, and the like. Thread scheduling is a process by which a scheduler 130 is configured, in an embodiment, to determine which thread is executed on which portion of a processing circuitry 140, at what time, and in what cycle order. In an embodiment a cycle refers to a time a core processes an input and provides an output. Generating a thread for processing is also known as spawning a thread. In certain embodiments, the scheduler 130 is implemented as a rasterizer circuitry. For example, in a GPU or GPGPU architecture, spawning is performed by a rasterizer, in an embodiment.

For example, in an embodiment, the scheduler 130 is configured to spawn a thread 142 which is processed by a core 141 of the processing circuitry 140. In an embodiment, a block is selected from the input tensor 110, and the scheduler 130 is configured to spawn a thread 142, which when processed by the core 141, results in a convolution between the block of the input tensor 110 and the kernel 120. In an embodiment a core 141 is a processing unit of a processing circuitry 140, which in some embodiments includes a plurality of processing cores. Such a plurality of processing cores is known as a multi-core processor, or multi-core processing system. In an embodiment, a processing circuitry 140 includes a core which is configured to process a single thread, a core which is configured to process multiple threads, multiple cores, combinations thereof, and the like. In some embodiments, a multi-core processor includes a first plurality of cores of a first type, and a second plurality of cores of a second type.

The output generated by each core of the processing circuitry 140 is a part of a generated output tensor 150. For example, in a convolutional neural network, an output tensor 150 is processed again with a second kernel, resulting in a second output, which is again processed with a third kernel, and so on.

In an embodiment, the processing circuitry 140 is configured to generate a plurality of output blocks. In some embodiments, the output tensor 150, the output blocks, and the like, are provided to a z-buffer unit 143. In an embodiment, the z-buffer unit 143 is configured to perform a depth test. In certain embodiments, the z-buffer unit 143 is configured to determine if any values of an output block, for example, exceed a threshold. In an embodiment, a threshold is any one of: dynamic, adaptive, and static.

A dynamic threshold changes in response to environmental variables, such as the variability of a received input. In an embodiment an adaptive threshold changes based on the tensor block (i.e., each tensor block has its own threshold). In some embodiments, an adaptive threshold is determined based on an average value which is determined based on averaging values of a tensor block. For example, in an embodiment an average value is determined for a first output block, and utilized as a threshold for the next (i.e., consecutive) output block.

A static threshold is a threshold which is predetermined and set. For example, a static threshold is, in an embodiment, a value of ‘1’. The z-buffer unit 143 is configured, in such an embodiment, to perform a depth test by determining if any value of a tensor block exceeds the predetermined threshold of ‘1’.

In some embodiments, the processing circuitry 140 is configured to assign a value to an indicator bit which is stored in a memory 144 together with a corresponding output block. In an embodiment, the memory 144 is an on-chip memory, an off-chip memory, a scratchpad memory, and the like. In certain embodiments, the indicator bit is stored with the corresponding output block.

In some embodiments, the indicator bit is stored in a first memory, and the corresponding output block is stored in a different memory. In an embodiment, an order, such as a physical address, in which indicator bits and output blocks are stored indicates the association between an indicator bit and output block. For example, the first indicator bit (i.e., the indicator bit having the top-most address) is associated with the first output block (i.e., the output block having the top-most address), the second indicator bit (i.e., the indicator bit having the next address) is associated with the second output block (i.e., the output block having the next address), etc.

For example, in an embodiment a value of the indicator bit indicates whether a tensor block is sparse, not sparse, and the like. In certain embodiments, a sparse block is a tensor block which can be treated as having all zero values. For such a block, performing processing (e.g., a convolution) utilizing it is a waste of compute resources, as the result will be zero, regardless of the input.

By configuring the z-buffer unit 143 to perform a depth test which determines if a block is sparse, and storing the result in an indicator bit, it is possible to avoid processing a block for which it is clear that the result would yield a zero. For example, in an embodiment the processing circuitry 140, the scheduler 130, and the like, are configured to read the indicator bit and determine a number of threads to spawn based on the indicator bit value.

Avoiding the operation with a sparse block allows some advantages, in an embodiment. In an embodiment, a processing circuitry 140 is configured to process another block utilizing a thread which would have otherwise been used to perform the operation on the sparse block. This results in faster processing, i.e., more processing is done in parallel, and is useful, for example, in providing an output from a neural network where providing a result in as little time as possible is a desired outcome.

In some embodiments, the processing circuitry 140 is configured to spawn less threads, which allows to perform a processing cycle utilizing less cores. This results in a power savings, as a core which is not used requires less power than a core which is used to perform an operation. In some embodiments, the processing circuitry 140 is configured to process another block (e.g., utilizing maximal threads), spawn less threads, a combination thereof, and the like.

In certain embodiments, a plurality of z-buffers are utilized, for example in a hierarchy. In an embodiment, a first first-level z-buffer performs a depth test on a first block, a second first-level z-buffer performs a depth test on a second block, etc. In certain embodiments, a second-level z-buffer performs a depth test on a block group, which includes the first block, the second block, etc. In some embodiments a single first-level z-buffer is utilized for the first block, second block, etc. and the second-level z-buffer performs a depth test on the block group.

This is advantageous as in an embodiment a block is determined to be not sparse relative to the small block size, but the block group is considered sparse when the block is compared, for example, to neighboring blocks. In some embodiments, a first threshold is determined for a first-level z-buffer, and a second threshold is determined for the second-level z-buffer. In an embodiment, each threshold is determined based on a different method, such as described in more detail above.

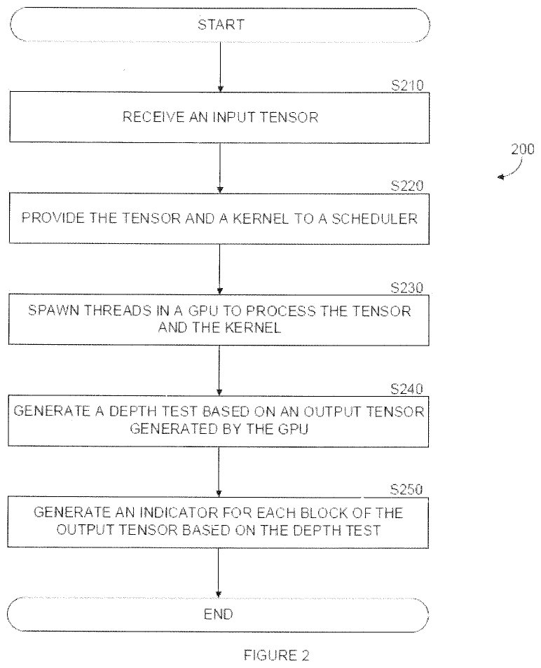

FIG. 2 is an example flowchart of a method for processing an input on a parallel processing circuitry utilizing a reduced thread spawn scheme, implemented in accordance with an embodiment.

At S210, an input tensor is received. In an embodiment, a tensor is a multi-dimensional array of values, represented as a data structure. In some embodiments, a tensor represents an input from an image. In certain embodiments, the input tensor is a two dimensional matrix, implemented for example as a data structure of two dimensional array of values. In some embodiments, a plurality of input tensors are received.

In an embodiment, a tensor is divisible into blocks. Each block is a data structure which includes a plurality of values. For example, a tensor represents, in an embodiment, an array of 1,024 by 1,024 pixels. A block is, in an embodiment, a 1 by 4 array of pixels, a 4 by 4 array of pixels, a 2 by 2 array of pixels, and the like.

At S220, the input tensor and a kernel are provided to a scheduler. In some embodiments, a portion of the input tensor (i.e., a block) is provided with a kernel to a scheduler. In an embodiment, a kernel is a data structure which includes an array of values, and may be implemented for example to represent a matrix. In some embodiments, a kernel is a convolutional layer of a neural network, a filter, a convolution matrix, a mask, and the like.

In certain embodiments, a processing circuitry is configured to process an input tensor and a kernel, for example by performing a convolution operation between the input tensor and the kernel.

At S230, a plurality of threads are spawned. In an embodiment, thread spawning is based on a size of the input tensor, a size of the kernel, a size of a block of the input tensor, a combination thereof, and the like. In an embodiment a thread includes an instruction to perform an operation, the operation performed by a core of a processing circuitry.

In some embodiments, the plurality of threads are provided, for example by a scheduler circuitry, to a plurality of cores of a processing circuitry, wherein each core is configured to receive a thread of the plurality of threads. For example, in an embodiment a thread is an instruction which when executed by a core generates a result of a multiplication operation between a value of the input tensor, and a value of the kernel.

At S240, a depth test is generated. In an embodiment, the depth test is performed on an output tensor, a block of an output tensor, a plurality of blocks of an output tensor, a combination thereof, and the like. In some embodiments, the output tensor is generated based on a result of processing the plurality of threads. For example, an output tensor includes, in an embodiment, values which are generated by performing a convolution between a kernel and an input tensor, a block of an input tensor, and the like. In an embodiment, an output tensor is utilized as an input tensor for another (e.g., consecutive) cycle of processing.

In some embodiments, the depth test is generated by a z-buffer unit of a processing circuitry. In certain embodiments, the depth test include generating a result to detect a minimum value, a maximum value, a combination thereof, and the like. For example, the depth test is performed in an embodiment by comparing each value of a block to each other value of the block, in order to determine the minimum value, the maximum value, a combination thereof, and the like.

In an embodiment, the depth test includes determining if the values of a block are within a threshold value. For example, the depth test includes, in an embodiment, determining if the values of the block are greater than (or less than) a threshold value. In some embodiments, a threshold value is signed. In certain embodiments, a threshold value is unsigned. For example, signed values are represented in an embodiment by 8 bits (i.e., values are between −127 and 127). As another example, unsigned values are represented in an embodiment by 8 bits (i.e., values between 0 and 255).

In certain embodiments, a plurality of depth tests are performed. For example, a first-level depth test is performed on a block of an output tensor, and a second-level depth test is performed on a plurality of blocks of the output tensor. In some embodiments, the plurality of blocks are neighboring blocks, i.e., each block is physically adjacent in a logical data structure to another block of the plurality of data blocks.

At S250, an indicator bit value is generated. In an embodiment, the depth test includes generating an indicator value for an indicator bit. The indicator bit value indicates, in an embodiment, if a block is sparse, or not sparse. For example, an indicator bit value of ‘1’ indicates, in an embodiment that the block is not sparse, while an indicator bit value of ‘0’ indicates that the block is sparse.

In certain embodiments, the indicator bit is stored with the corresponding output block. In some embodiments, the indicator bit is stored in a first memory, and the corresponding output block is stored in a second memory. In an embodiment, an order, such as a physical address, in which indicator bits and output blocks are stored indicates the association between an indicator bit and output block. For example, the first indicator bit (i.e., the indicator bit having the top-most address) is associated with the first output block (i.e., the output block having the top-most address), the second indicator bit (i.e., the indicator bit having the next address) is associated with the second output block (i.e., the output block having the next address), etc.

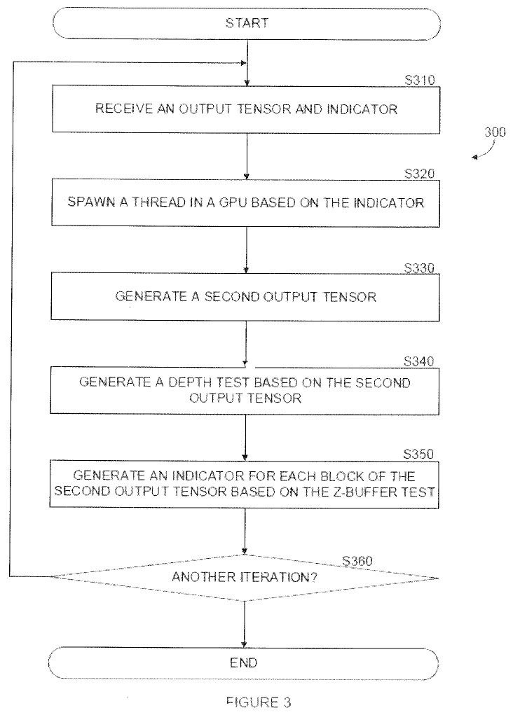

FIG. 3 is an example of a flowchart of a method for spawning threads in a processing circuitry, implemented in accordance with an embodiment.

At S310, an output tensor and corresponding indicator are received. In an embodiment, an output tensor is a multi-dimensional array of values, represented as a data structure. In some embodiments, an output tensor is generated based on processing an input tensor and a kernel. In certain embodiments, the output tensor is a two dimensional matrix, implemented for example as a data structure of two dimensional array of values. In some embodiments, a plurality of output tensors are received.

In an embodiment, an output tensor is divisible into blocks. Each block is a data structure which includes a plurality of values. For example, a tensor represents, in an embodiment, an array of 1,024 by 1,024 pixels. A block is, in an embodiment, a 1 by 4array of pixels, a 4 by 4 array of pixels, a 2 by 2 array of pixels, and the like.

In some embodiments, an indicator is an indicator bit, having a binary value (i.e., ‘1’ or ‘0’). In certain embodiments, the indicator bit represents a state of the output tensor, a block of the output tensor, a plurality of blocks of the output tensor, and the like. A state is, according to an embodiment, sparse, and not sparse. In an embodiment, a sparse tensor, a sparse tensor block, and the like, is a data structure having all zero values, mostly zero values (e.g., based on a threshold for a number of values), and the like. In certain embodiments sparsity is defined based on a threshold value, for example as discussed in more detail herein.

At S320, a thread is spawned based on the indicator. In an embodiment, the thread is spawned for a computing core of a processing circuitry. For example, spawning threads is performed in a GPU pipeline by a scheduler circuitry, such as a rasterizer. In an embodiment, a plurality of threads are spawned, each thread corresponding to an indicator bit value associated with an output block of an output tensor.

For example, according to an embodiment, a scheduler is configured to read the indicator bit, and based on the value of the indicator bit, spawn a thread for processing an output block associated with the indicator bit. In some embodiments, the scheduler does not spawn a thread for processing the output block, in response to reading the indicator bit value which corresponds with a value indicating that the output block is sparse. In an embodiment a thread includes an instruction to perform an operation, the operation performed by a core of a processing circuitry.

At S330, a second output tensor is generated. In an embodiment, the second output tensor is generated by processing the received output tensor and a kernel. For example, in an embodiment processing the received output tensor includes reading an indicator bit value, determining that the output block corresponding to the indicator bit should be processed, and processing the output block by instructing a processing circuitry to perform a convolution between the output block and a kernel.

In an embodiment, the second output tensor includes a plurality of blocks, each block generated by processing a portion of a plurality of threads on a processing circuitry including a plurality of processing cores.

At S340, a depth test is generated for the second output tensor. In an embodiment, the depth test is performed on the second output tensor, a block of the second output tensor, a plurality of blocks of the second output tensor, a combination thereof, and the like.

In some embodiments, the second output tensor is generated based on a result of processing a spawned thread. For example, a second output tensor includes, in an embodiment, values which are generated by performing a convolution between a kernel and a received output tensor, a block of a received output tensor, and the like.

In some embodiments, the depth test is generated by a z-buffer unit of a processing circuitry. In certain embodiments, the depth test includes generating a result to detect a minimum value, a maximum value, a combination thereof, and the like. For example, the depth test is performed, in an embodiment, by comparing each value of a block of the second output tensor, to each other value of the block, in order to determine the minimum value, the maximum value, a combination thereof, and the like.

In an embodiment, the depth test includes determining if the values of a block are within a threshold value. For example, the depth test includes, in an embodiment, determining if the values of the block are greater than (or less than) a threshold value. In some embodiments, a threshold value is signed. In certain embodiments, a threshold value is unsigned. For example, signed values are represented in an embodiment by 8 bits (i.e., values are between −127 and 127). As another example, unsigned values are represented in an embodiment by 8 bits (i.e., values between 0 and 255).

In certain embodiments, a plurality of depth tests are performed. For example, a first-level depth test is performed on a block of an output tensor, and a second-level depth test is performed on a plurality of blocks of the second output tensor. In some embodiments, the plurality of blocks are neighboring blocks, i.e., each block is physically adjacent in a logical data structure to another block of the plurality of data blocks.

At S350, an indicator bit value is generated. In an embodiment, the depth test includes generating an indicator value for an indicator bit. The indicator bit value indicates, in an embodiment, if a block is sparse. In an embodiment, the indicator bit value indicates that the block is not sparse. For example, an indicator bit value of ‘1’ indicates, in an embodiment that the block is not sparse, while an indicator bit value of ‘0’ indicates that the block is sparse.

In certain embodiments, the indicator bit is stored with the corresponding output block. In some embodiments, the indicator bit is stored in a first memory, and the corresponding output block is stored in a second memory. In an embodiment, an order, such as a physical address, in which indicator bits and output blocks are stored indicates the association between an indicator bit and output block. For example, the first indicator bit (i.e., the indicator bit having the top-most address) is associated with the first output block (i.e., the output block having the top-most address), the second indicator bit (i.e., the indicator bit having the next address) is associated with the second output block (i.e., the output block having the next address), etc.

At S360, a check is performed to determine if another processing cycle should be performed. For example, a processing cycle includes in an embodiment processing an output tensor and a kernel to generate a second output tensor. The second output tensor is then processed in a next cycle with a second kernel. These iterations are performed, in an embodiment, until all output tensors, convolutional layers, fully connected layers, kernels, and the like, have been processed. If another processing cycle should be performed execution continues at S360, according to an embodiment. If another processing cycle should not be executed, for example due to processing all required tensors, execution ends, in an embodiment.

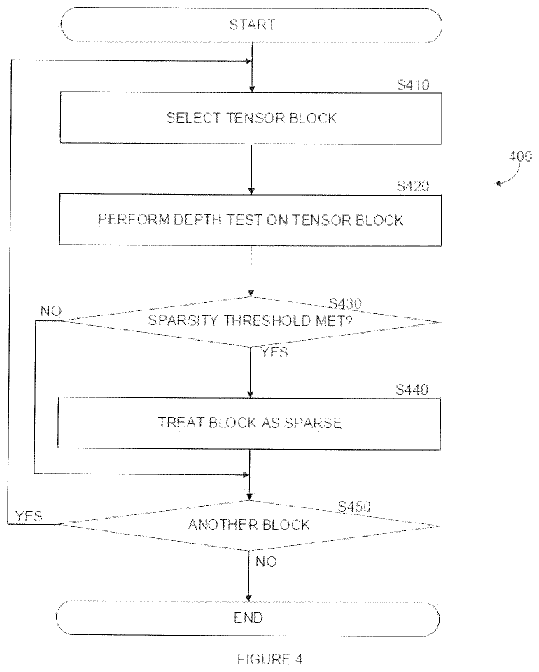

FIG. 4 is an example of a flowchart of a method for determining a sparse tensor utilized in spawning threads in a processing circuitry, implemented in accordance with an embodiment. In certain embodiments, the determination of what constitutes a sparse tensor is useful, as it allows to determine sparse tensors, tensors that are effectively sparse, and the like, and allow the processing circuitry, at the next processing cycle, to refrain from processing such tensors where there results would result in zero, close to zero, etc.

At S410, a tensor block is selected. In an embodiment, a tensor block is selected from an input tensor, an output tensor, another tensor block having a block size larger than the tensor block, and the like. In some embodiments, a tensor block is a data structure including a two-dimensional array of values, for example stored in a computer memory, an on-chip memory, an off-chip memory, a storage, and the like.

In an embodiment, a tensor is divisible into blocks. Each block is a data structure which includes a plurality of values. For example, a tensor represents, in an embodiment, an array of 1,024 by 1,024 pixels. A block is, in an embodiment, a 1 by 4 array of pixels, a 4 by 4 array of pixels, a 2 by 2 array of pixels, and the like.

At S420, a depth test is performed on the selected tensor block. In an embodiment, the depth test is performed on the selected tensor block, on a block which includes the selected tensor block, a combination thereof, and the like.

In some embodiments, the depth test is generated by a z-buffer unit of a processing circuitry. In certain embodiments, the depth test includes generating a result to detect a minimum value, a maximum value, a combination thereof, and the like. For example, the depth test is performed, in an embodiment, by comparing each value of the selected block, to each other value of the block, in order to determine the minimum value, the maximum value, a combination thereof, and the like.

In certain embodiments, a plurality of depth tests are performed. For example, a first-level depth test is performed on a selected block of a tensor, and a second-level depth test is performed on a plurality of blocks of the tensor, which includes the selected block. In some embodiments, the plurality of blocks are neighboring blocks, i.e., each block is physically adjacent in a logical data structure to another block of the plurality of data blocks.

At S430, a check is performed to determine if the selected block meets a sparsity condition. If ‘yes’ execution continues at S440, otherwise execution continues at S450. In an embodiment, meeting a sparsity condition includes determining that values, value averages, and the like, meet, exceed, or are below, a threshold. For example, in an embodiment a block is determined to be sparse where all values of the block are zero. In some embodiments, a block is determined to be sparse where an average of all values of the blocks is below a predetermined threshold. In certain embodiments, a block is determined to be sparse if a first condition is met (e.g., average of values is below a predetermined threshold) and a second condition is met (e.g., an adjacent block is previously determined to be sparse.

In an embodiment, the depth test includes determining if the values of a block are within a threshold value. For example, the depth test includes, in an embodiment, determining if the values of the block are greater than (or less than) a threshold value. In some embodiments, a threshold value is signed. In certain embodiments, a threshold value is unsigned. For example, signed values are represented in an embodiment by 8 bits (i.e., values are between −127 and 127). As another example, unsigned values are represented in an embodiment by 8 bits (i.e., values between 0 and 255).

At S440, the selected block is treated as a sparse block. In an embodiment, a block is treated as sparse by storing a value for an indicator bit associated with the block. For example, in an embodiment an indicator bit value is generated based on the depth test.

In an embodiment, the depth test includes generating an indicator value for an indicator bit. The indicator bit value indicates, in an embodiment, if a block is sparse. In an embodiment, the indicator bit value indicates that the block is not sparse. For example, an indicator bit value of ‘1’ indicates, in an embodiment that the block is not sparse, while an indicator bit value of ‘0’ indicates that the block is sparse.

In certain embodiments, the indicator bit is stored with the corresponding block. In some embodiments, the indicator bit is stored in a first memory, and the corresponding output block is stored in a second memory. In an embodiment, an order, such as a physical address, in which indicator bits and output blocks are stored indicates the association between an indicator bit and output block. For example, the first indicator bit (i.e., the indicator bit having the top-most address) is associated with the first output block (i.e., the output block having the top-most address), the second indicator bit (i.e., the indicator bit having the next address) is associated with the second output block (i.e., the output block having the next address), etc.

At S450, a check is performed to determine if another block should be selected. If ‘yes’, execution continues at S410. If ‘no’, execution terminates. In an embodiment blocks of a tensor are serially selected until all blocks have been tested for sparsity.

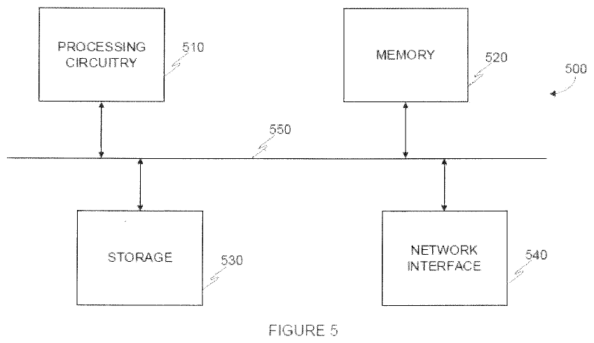

FIG. 5 is an example schematic diagram of a system 500 utilizing a processing pipeline for reducing thread spawning, implemented according to an embodiment. The system 500 includes a processing circuitry 510 coupled to a memory 520, a storage 530, and a network interface 540. In an embodiment, the components of the system 500 may be communicatively connected via a bus 550.

The processing circuitry 510 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

In an embodiment the processing circuitry 510 includes a processing pipeline such as described in more detail in FIG. 1 above. In certain embodiments the processing circuitry 510 includes a scheduler, an on-chip memory, a depth test unit, a z-buffer, a rasterizer, a combination thereof, and the like.

The memory 520 may be volatile (e.g., random access memory, etc.), non-volatile (e.g., read only memory, flash memory, etc.), or a combination thereof. In some embodiments, the memory 520 is configured to store a tensor, a block of a tensor, an indicator bit, and the like.

In one configuration, software for implementing one or more embodiments disclosed herein may be stored in the storage 530. In another configuration, the memory 520 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 510, cause the processing circuitry 510 to perform the various processes described herein.

The storage 530 may be magnetic storage, optical storage, and the like, and may be realized, for example, as flash memory or other memory technology, or any other medium which can be used to store the desired information.

It should be understood that the embodiments described herein are not limited to the specific architecture illustrated in FIG. 5, and other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for thread reduction in tensor processing, comprising:
generating a result of a block of a tensor input with a predefined kernel on a processing circuitry, the processing circuitry configured to process in parallel a plurality of threads;
performing a depth test on the generated result;
generating for an indicator bit a first indicator bit value based on the depth test, the first indicator bit value indicating that the result is sparse;
generating for the indicator bit a second indicator bit value based on the depth test, the second indicator bit value indicating that the result is not sparse; and
spawning a thread for processing the result and a second predefined kernel, based on the indicator bit having the second indicator bit value.

2. The method of claim 1, further comprising:
storing the result and a value of the indicator bit in a memory.

3. The method of claim 1, further comprising:
generating for the indicator bit a value indicating that the result is sparse, in response to determining that the depth test indicates that sparsity of the block is within a threshold value.

4. The method of claim 3, wherein the threshold is any one of: dynamic, static, and adaptive.

5. The method of claim 1, further comprising:
performing a second depth test on a plurality of results, the plurality of results including the generated result.

6. The method of claim 5, further comprising:
generating for the indicator bit the first indicator bit value based on the second depth test, the first indicator bit value indicating that the result is sparse.

7. The method of claim 1, wherein the generated result is a block representing a plurality of pixels.

8. The method of claim 1, further comprising:
processing the thread on a core of the processing circuitry, wherein the processing circuitry is a multi-core processing circuitry; and
generating a second result based on an output of the core.

9. The method of claim 8, further comprising:
generating the second result further based on a plurality of zero values, in response to determining that the indicator bit has the first indicator bit value.

10. The method of claim 1, further comprising:
performing structured pruning of the predefined kernel.

11. The method of claim 1, further comprising:
performing unstructured pruning of the predefined kernel.

12. The method of claim 1, further comprising:
generating a value for the indicator bit based on a weight associated with the predefined kernel.

13. The method of claim 1, further comprising:
quantizing a value of the block, wherein the block includes a plurality of values.

14. The method of claim 13, wherein the value is stored as a floating point value, and the quantized value is stored as an integer.

15. A non-transitory computer readable medium having stored thereon instructions for causing a processing circuitry to execute a process, the process comprising:
generating a result of a block of a tensor input with a predefined kernel on a processing circuitry, the processing circuitry configured to process in parallel a plurality of threads;
performing a depth test on the generated result;
generating for an indicator bit a first indicator bit value based on the depth test, the first indicator bit value indicating that the result is sparse;
generating for the indicator bit a second indicator bit value based on the depth test, the second indicator bit value indicating that the result is not sparse; and
spawning a thread for processing the result and a second predefined kernel, based on the indicator bit having the second indicator bit value.

16. A system for thread reduction in tensor processing, comprising:
a processing circuitry; and
a memory, the memory containing instructions that, when executed by the processing circuitry, configure the system to:
generate a result of a block of a tensor input with a predefined kernel on a processing circuitry, the processing circuitry configured to process in parallel a plurality of threads;
perform a depth test on the generated result;
generate for an indicator bit a first indicator bit value based on the depth test, the first indicator bit value indicating that the result is sparse;
generate for the indicator bit a second indicator bit value based on the depth test, the second indicator bit value indicating that the result is not sparse; and
spawn a thread for processing the result and a second predefined kernel, based on the indicator bit having the second indicator bit value.

17. The method of claim 16, further comprising:
storing the result and a value of the indicator bit in a memory.

18. The method of claim 16, further comprising:
generating for the indicator pit a value indicating that the result is sparse, in response to determining that the depth test indicates that sparsity of the block is within a threshold value.

19. The method of claim 18, wherein the threshold is any one of: dynamic, static, and adaptive.

20. The method of claim 16, further comprising:
performing a second depth test on a plurality of results, the plurality of results including the generated result.

21. The method of claim 20, further comprising:
generating for the indicator bit the first indicator bit value based on the second depth test, the first indicator bit value indicating that the result is sparse.

22. The method of claim 16, wherein the generated result is a block representing a plurality of pixels.

23. The method of claim 16, further comprising:
processing the thread on a core of the processing circuitry, wherein the processing circuitry is a multi-core processing circuitry; and
generating a second result based on an output of the core.

24. The method of claim 23, further comprising:
generating the second result further based on a plurality of zero values, in response to determining that the indicator bit has the first indicator bit value.

25. The method of claim 16, further comprising:
performing structured pruning of the predefined kernel.

26. The method of claim 16, further comprising:
performing unstructured pruning of the predefined kernel.

27. The method of claim 16, further comprising:
generating a value for the indicator bit based on a weight associated with the predefined kernel.

28. The method of claim 16, further comprising:
quantizing a value of the block, wherein the block includes a plurality of values.

29. The method of claim 28, wherein the value is stored as a floating point value, and the quantized value is stored as an integer.
